(19) United States
(12) Patent Application Publication
(10) Pub. No.: US 2007/0150767 A1
(43) Pub. Date: Jun. 28, 2007

(54) Information processing apparatus and power supply control method

(75) Inventors: Hirohito Motomiya, Higashiyamato-shi (JP); Shizuo Morioka, Hanno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/641,697

(22) Filed: Dec. 20, 2006

(30) Foreign Application Priority Data
Dec. 27, 2005 (JP) 2005-376509

(51) Int. Cl. G06F 1/00

(52) U.S. Cl. 713/300

(57) ABSTRACT

According to one embodiment, control is executed to make the number of times of obtaining a current value output from a power supply unit to a CPU greater than the number of times of obtaining current values output from power supply units to DV #1, DV #2, DV #3 and DV #4.

### CROSS-REFERENCE TO RELATED APPLICATIONS

This application is based upon and claims the benefit of priority from Japanese Patent Application No. 2005-376509, filed Dec. 27, 2005, the entire contents of which are incorporated herein by reference.

### BACKGROUND

1. Field

One embodiment of the invention relates to an information processing apparatus and a power supply control method.

2. Description of the Related Art

Various kinds of multiple-output power supply units outputting plural kinds of stabilized DC power supplies have been developed. In addition, various kinds of stabilized DC power supply units capable of PWM control of DC-DC converters have been developed. A technique of allowing a micro-computer to read an output of a comparator comparing an output voltage and a target voltage and controlling a duty ratio of PWM, in a power supply unit, is disclosed in, for example, Jpn. Pat. Appln. KOKAI Publication No. 10-225115.

According to this technique, however, stable power supply to an apparatus in which load variation is great is often difficult. In addition, power supply cannot be executed by predicting the load variation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a configuration of a notebook PC equipped with an information processing apparatus according to an embodiment of the present invention;

FIG. 2 is an exemplary block diagram showing a system configuration of main parts of a computer serving as the information processing apparatus using a multiple-output power supply unit;

FIG. 3 is an exemplary block diagram showing a detailed configuration of the multiple-output power supply unit;

FIG. 4 is an exemplary block diagram showing details of a power supply unit;

FIG. 5 is an exemplary block diagram showing a configuration of the multiple-output power supply unit, including the details of the power supply unit;

FIG. 6 is an exemplary flowchart showing a power supply control method to which the information processing apparatus of the present invention is applied; and

FIG. 7 is an exemplary graph showing an example of a method of calculating a threshold value of variation in an output current handled as a current value.

### DETAILED DESCRIPTION

Various embodiments according to the invention will be described hereinafter with reference to the accompanying drawings. In general, according to one embodiment of the invention, an information processing apparatus includes a first device, a first power supply unit supplying an electric power to operate the first device, a second device different from the first device, a second power supply unit supplying an electric power to operate the second device, and control means for executing control to make number of times of obtaining a current value output from the first power unit to the first device greater than number of times of obtaining a current value output from the second power supply unit to the second device.

An embodiment of the present invention will be explained below with reference to the accompanying drawings.

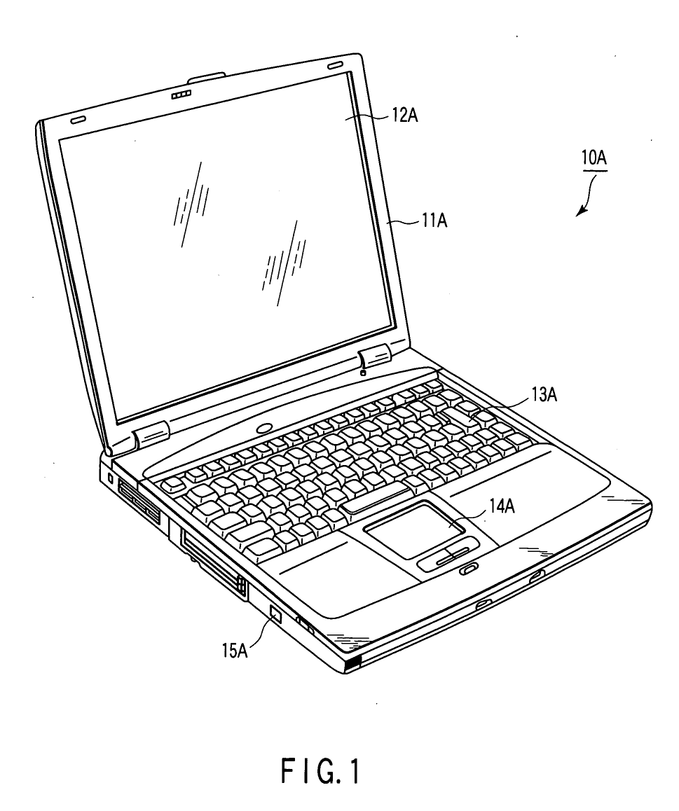

FIG. 1 shows a system configuration of an information processing apparatus according to an embodiment of the present invention. The information processing apparatus is implemented as a battery-operated notebook computer 10A. The computer 10A is composed of a computer body and a display unit 11A as shown in FIG. 1. A display device composed of an LCD (Liquid Crystal Display) is embedded in the display unit 11A. A display screen 12A of the LCD is located approximately at the center of the display unit 11A.

The display unit 11A is attached to the computer 10A so as to freely pivot between an opened position and a closed position. The main body of the computer 10A comprises a housing shaped in a thin box, and comprises a keyboard 13A on a top face, a touch pad 14A on a palm rest, an optical drive unit 15A on a side face, etc.

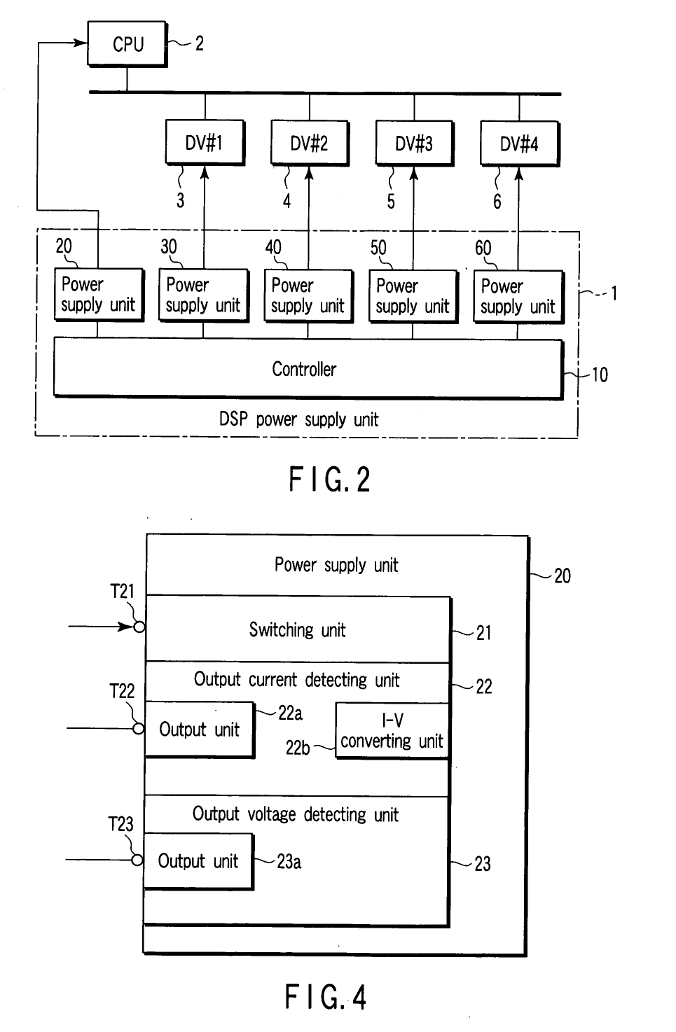

FIG. 2 is a block diagram showing a system configuration of the computer comprising a multiple-output power supply unit.

The personal computer 10A comprises a CPU 2 which is in charge of system control and a plurality of devices (DV#1, DV#2, . . . , DV#4) 3, 4, . . . , 6 configured to execute various kinds of operations under control of the operations of the CPU 2. These devices are, for example, a graphics controller, a communication controller, an embedded controller, a bus bridge and other system components. The personal computer 10A further comprises a multiple-output power supply unit (digital power supply unit employing a DSP (Digital Signal Processor)) 1 which comprises power supply units 20, 30, 40, 50 and 60 and a controller 10. Each of the power supply units 20, 30, 40, 50 and 60 is, for example, a device such as a DC-DC converter.

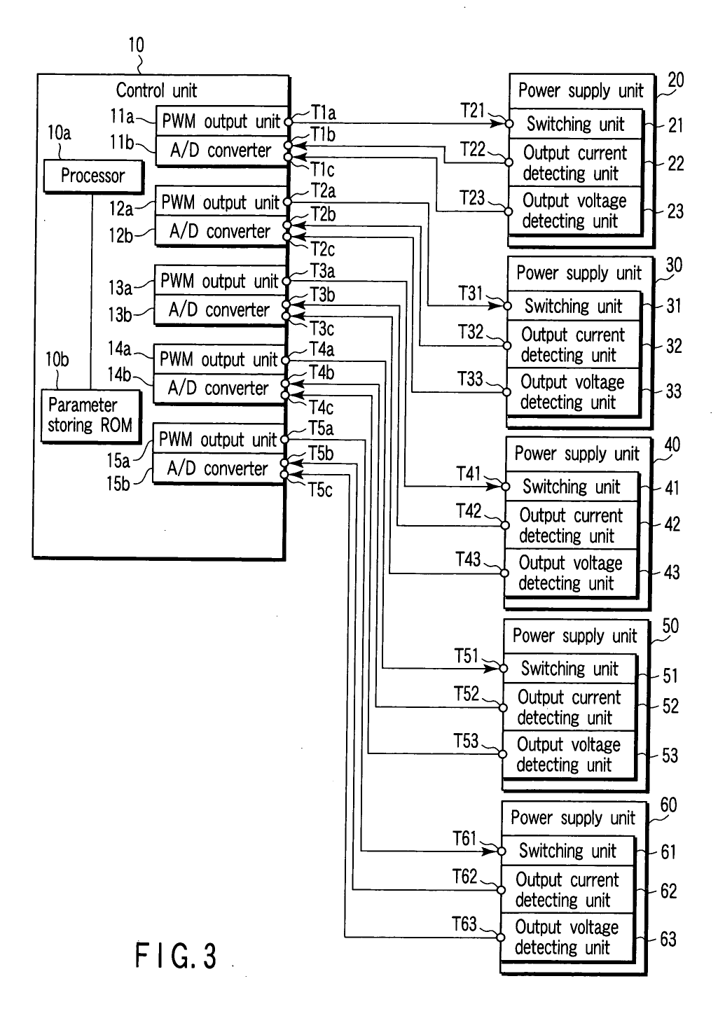

FIG. 3 is a block diagram showing a detailed configuration of the multiple-output power supply unit.

The multiple-output power supply unit 1 is configured to comprise the controller 10 and the power supply units 20, 30, 40, 50 and 60.

The controller 10 serving as a DSP corresponds to the power supply units 20, 30, 40, 50 and 60 and is configured to comprise a plurality of PWM output units 11a, 12a, 13a, 14a and 15a and A/D converters 11b, 12b, 13b, 14b and 15b, and a ROM 10b storing parameters. The controller 10 further comprises PWM signal output terminals T1a, T2a, T3a, T4a and T5a and control input terminals T1b, T2b, T3b, T4b, T5b, T1c, T2c, T3c, T4c and T5c to form feedback loops.

The processor 10a calculates pulse widths of PWM signals output from the PWM output units 11a, 12a, 13a, 14a and 15a, with reference to the values of the A/D converters 11b, 12b, 13b, 14b and 15b, for the respective feedback loops of the power supply units 20, 30, 40, 50 and 60, on the basis of a predetermined control frequency. The processor 10a controls output pulse widths (on duty) of the PWM signals output from the PWM output units 11a, 12a, 13a, 14a and 15a, on the basis of the calculated pulse widths of the PWM signals.

The power supply units 20, 30, 40, 50 and 60 comprise switching units 21, 31, 41, 51 and 61, output current detecting units 22, 32, 42, 52 and 62, and output voltage detecting units 23, 33, 43, 53 and 63, respectively, and, to form the feedback loops, PWM signal input terminals T21, T31, T41, T51 and T61, current output terminals T22, T32, T42, T52 and T62, and voltage output terminals T23, T33, T43, T53 and T63, respectively.

The CPU supply unit 20 is a load body which requires a high-speed response in the feedback loop and whose load variation is great. As the power supply unit 20, for example, a power supply unit feeding the operation power to the CPU is assumed. As the power supply units 30, 40, 50 and 60, power supply units operating under control of the CPU, i.e. feeding the operation power supply to devices such as IO, peripheral devices, etc. are assumed.

As the power supply units 30, 40, 50 and 60, power supply units operating under control of the CPU, i.e. feeding the operation power supply to devices such as IO, peripheral devices, etc. are assumed.

The PWM signal output terminal T1a of the controller 10 is connected to the PWM signal output terminal T21 of the power supply unit 20, and the current output terminal T22 and the voltage output terminal T23 of the power supply unit 20 are connected to the control input terminals T1b and T1c of the controller 10, respectively, to form the feedback loop of the power supply unit 20.

The PWM signal output terminal T2a of the controller 10 is connected to the PWM signal output terminal T31 of the power supply unit 30, and the current output terminal T32 and the voltage output terminal T33 of the power supply unit 30 are connected to the control input terminals T2b and T2c of the controller 10, respectively, to form the feedback loop of the power supply unit 30.

Furthermore, the feedback loops are formed between the controller 10, and the power supply units 40, 50 and 60.

The controller 10 comprises a ROM 10b separating the PWM control circuits into a predetermined number of groups and setting different control frequencies (frequencies of control based on the control loops) for the respective groups. In accordance with a control parameter set in the ROM lob, the controller 10 sets the control frequency designated by the parameter for the power supply unit which belongs to the group designated by the parameter, and executes the control by using the feedback loop on the basis of the control frequency. The parameter set in the ROM 10b can be changed (updated) arbitrarily. If the parameter is not set in the ROM 10b, for example, controlling the pulse width by using the feedback loop may be repeated in a certain cycle, with the frequency equal for all the power supply units 20, 30, 40, 50 and 60 that are to be controlled.

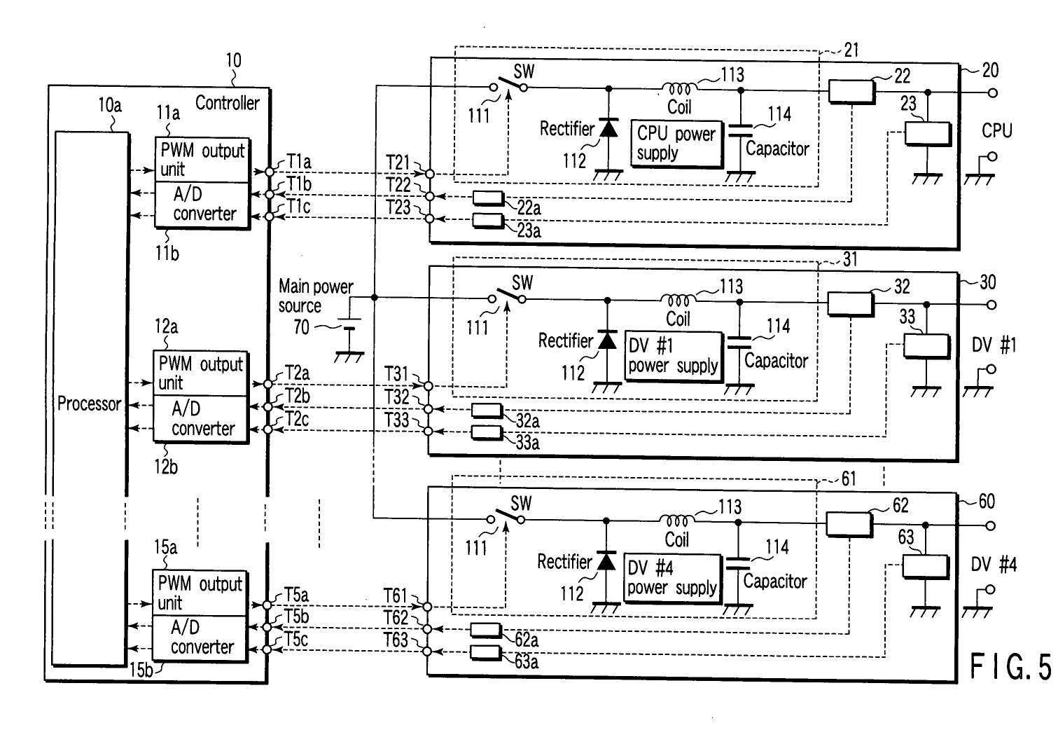

The output current detecting unit 22 comprises an output unit 22a and an I-V converting unit 22b as shown in, for example, FIG. 4. The output voltage detecting unit 23 comprises an output unit 23a. The I-V converting unit 22b converts a detected current value into a voltage value representing a current value.

FIG. 5 shows a configuration of the multiple-output power supply unit, including details of the power supply units.

The power supply units 20, 30, . . . , 60 are connected to a main power supply 70. An output power of the power supply unit 20 is fed to a CPU 2. Output powers of the power supply units 30, . . . , 60 are fed to the respective devices (DV#1, . . . , DV#4).

The power supply unit 20 is composed of the switching unit 21, the output current detecting unit 22 and the output voltage detecting unit 23. The switching unit 21 is composed of a switch 111, a rectifier 112, a coil 113, a capacitor 114, a power source, etc. The power supply units, 30, 40, 50 and 60 have the same configuration as that of the power supply unit 20.

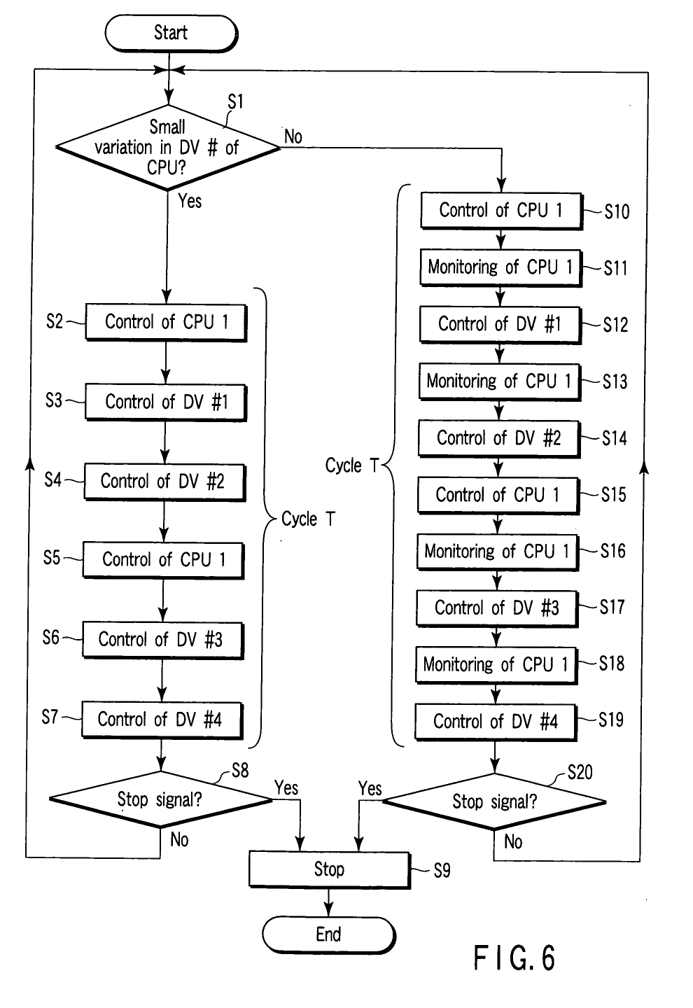

FIG. 6 shows a flowchart of a power supply controlling method applied to the information processing apparatus of the present invention.

For example, a current value of a load body which requires a high-speed response is monitored and a load body having great load variation is preferable. The load body is explained below as, for example, a CPU.

In the following descriptions, “monitoring of CPU” indicates a processing of obtaining a current value (for example, current value A) fed to the CPU and “control of CPU” indicates a processing of obtaining a current value (for example, current value B) fed to the CPU and then executing the PWM control on the basis of the current values A and B if the current value A obtained by “monitoring of CPU” is maintained on the basis of the obtained current value B.

The controller 10 discriminates whether or not the obtained current value fed to the CPU exceeds a predetermined threshold value stored in the ROM 10b (block S1). If it is discriminated that the obtained current value does not exceed a predetermined threshold value stored in the ROM 10b (YES in block S1), the controller 10 obtains the current value from the power supply unit 20 at two times in, for example, a cycle T (T/2: first interval).

The PWM control is executed by the PWM control circuit in cycle T/2 on the basis of the current value. In other words, the PWM control is executed on the basis of the obtained current value fed to the CPU (block S2: control of the CPU). More specifically, the processor 1a of the controller 10 compares a digital current value A/D-converted by the A/D converter 11b to a previously obtained current value and transmits to the PWM output unit 11a data which is necessary to the PWM control signal, for example, a Duty ratio.

Subsequently, the PWM control is executed on the basis of the obtained current value for DV #1 (block S3: control of DV #1), the PWM control is executed on the basis of the obtained current value for DV #2 (block S4: control of DV #2), the PWM control is executed on the basis of the obtained current value to be fed to the CPU (block S5: control of the CPU), the PWM control is executed on the basis of the obtained current value for DV #3 (block S6: control of DV #3), and the PWM control is executed by the PWM control circuit on the basis of the obtained current value for DV #4 (block S7: control of DV #4).

If the controller 10 does not receive, for example, a stop signal transmitted from a power supply microcomputer (NO in block S8), the operation shifts to the block S1. On the other hand, if the controller 10 receives, for example, a stop signal transmitted from a power supply microcomputer, the controller 10 stops the above-explained processing (block S9).

If the controller 10 discriminates that the obtained current value exceeds the predetermined threshold value stored in the ROM lob (NO in block Si), the controller 10 further executes the block “monitoring of the CPU” at, for example, four additional times, in the cycle T. In other words, the controller 10 switches to the mode of obtaining the current value (i.e. mode of monitoring the CPU) at totally six times including two times at which the current value fed to the CPU is obtained under “control of the CPU”. The control is executed in cycle T/2 while the cycle of obtaining the current value is T/6.

The PWM control is executed on the basis of the obtained current value fed to the CPU (block S10: control of the CPU). The current value fed to the CPU is obtained (monitored) (block S11: monitoring of the CPU). The PWM control is executed on the basis of the obtained current value for DV #1 (block S12: control of DV #1). The current value fed to the CPU is obtained (block S13: monitoring of the CPU). The PWM control is executed on the basis of the obtained current value for DV #2 (block S14: control of DV #2). The PWM control is executed on the basis of the obtained current value fed to the CPU (block S15: control of the CPU). The current value fed to the CPU is obtained (block S16: monitoring of the CPU). The PWM control is executed on the basis of the obtained current value for DV #3 (block S17: control of DV #3). The current value fed to the CPU is obtained (block S.18: monitoring of the CPU). The PWM control is executed on the basis of the obtained current value for DV #4 (block S19: control of DV #4).

If the controller 10 does not receive, for example, a stop signal transmitted from a power supply microcomputer (NO in block S20), the operation shifts to the block S1. On the other hand, if the controller 10 receives, for example, a stop signal transmitted from a power supply microcomputer, the controller 10 stops the above-explained processing (block S9).

As described above, if the obtained threshold value fed to the CPU exceeds the predetermined threshold value stored in the ROM 10b, the controller increases the number of times of obtaining the current value fed to the CPU. In addition, if the obtained current value is lowered, for example, in period T/2 at two successive times, the number of times of obtaining the current value fed to the CPU may also be increased. The control corresponding to the variation in the current value can be executed by increasing the number of times of obtaining the current value.

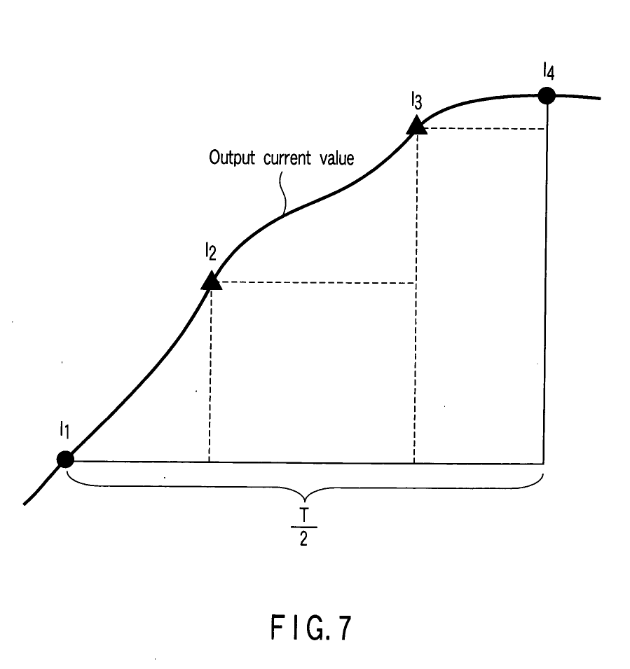

Next, an example of a method of calculating the threshold value of the variation in the output current is described with reference to FIG. 7. In the figure, the “monitoring of the CPU” is executed at the points of time represented by triangle marks and the “control of the CPU” is executed at the points of time represented by round marks.

The figure shows a case where the output current is varied from I₁ to I₄ in period T/2.

First, in a state in which there is not I₂ or I₃ representing the “monitoring of the CPU” (i.e. block S2 to S7 in FIG. 5), the variation in the current is represented by formula (1):
ΔI=I₄−I₁ (1)

Since two points I₁ and I₄ alone are measured, only linear variation can be recognized.

In a state in which I₂ and I₃ representing the “monitoring of the CPU” (blocks S10 to S19 in FIG. 5), the variation in the current is represented by formula (2):

$$Δ I = a ( {I}_{2} - {I}_{1} ) + b ( {I}_{3} - {I}_{2} ) + c ( {I}_{4} - {I}_{3} ) \qquad ( 2 )$$

where a, b and c represent coefficients for giving weight. For example, accuracy can be improved by giving more weights on the immediate current variation that is currently measured current.

Thus, the variation matching the real value more exactly can be recognized and an optimum feedback of the PWM control can be executed by executing the “monitoring of the CPU” and increasing the number of times of the current measurement.

In addition, if conditions of the following formula are satisfied, a great output variation is recognized and the switching to the mode of executing the “monitoring of the CPU” (blocks S10 to S19 in FIG. 5) is executed. Parameters of these conditions are stored in the memory ROM 10b and can be arbitrarily varied by 10%.
|ΔIₙ−ΔIₙ₋₁|≧10% (3)

ΔIₙ: currently measured and obtained current variation.

ΔIₙ₋₁: previously measured and obtained current variation.

A next amount of the variation can also be estimated by sequentially measuring the amount of the current variation [ΔIₙ−ΔIₙ₋₁].

As described above, the response speed of the control can be arbitrarily varied and set in accordance with the characteristics of individual load bodies connected to the multiple-output power supply, by unit of the individual output power supplies. A stable electric power can be thereby fed optimally to all the loads, without a high-speed processor, in the multiple-output power supply which shares the power supply for a plurality of loads including loads requiring a high-speed response.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a first device;
a first power supply unit supplying an electric power to operate the first device;
a second device different from the first device;
a second power supply unit supplying an electric power to operate the second device; and
control means for executing control to make number of times of obtaining a current value output from the first power unit to the first device greater than number of times of obtaining a current value output from the second power supply unit to the second device.

2. The apparatus according to claim 1, wherein the control means increases the number of times of obtaining a current value output from the first power supply unit to the first device, in accordance with increase in variation amount of the current value output from the first power supply unit to the first device.

3. The apparatus according to claim 1, further comprising a first PWM control unit PWM-controlling the first power supply unit,
wherein the control means obtains the current value output from the first power supply unit to the first device, and sets a pulse width of a PWM signal output from the first PWM control unit to the first power supply unit in accordance with the obtained current value.

4. An information processing apparatus, comprising:
a device;
a power supply unit supplying an electric power to operate the device; and
control means for obtaining at a first interval a current value output from the power supply unit to the device and executing PWM control for the power supply unit at the first interval in accordance with the current value obtained at the first interval, and if a variation amount of the obtained current value is increased, obtaining the current value output from the power supply unit to the device at a second interval smaller than the first interval and executing the PWM control for the power supply unit at the second interval in accordance with the current value obtained at the second interval.

5. The apparatus according to claim 4, wherein the control means discriminates a current value variation by comparing the obtained current value of the power supply unit and a current value obtained immediately before the obtained current value.

6. The apparatus according to claim 4, wherein if the current value obtained at the first interval is successively lowered, the control means obtains the current value output from the power supply unit to the device at the second interval smaller than the first interval.

7. The apparatus according to claim 4, further comprising a PWM control unit executing PWM control of the power supply unit,
wherein the control means obtains the current value output from the power supply unit to the device, and sets a pulse width of a PWM signal output from the PWM control unit to the power supply unit in accordance with the obtained current value.

8. The apparatus according to claim 4, wherein the control means estimates a current value of the power supply means with the obtained current value to execute control.

9. A method of controlling an information processing apparatus comprising a first device, a first power supply unit supplying an electric power to operate the first device, a second device different from the first device, and a second power supply unit supplying an electric power to operate the second device,
the method comprising a controlling step of executing control to make number of times of obtaining a current value output from the first power supply unit to the first device greater than number of times of obtaining a current value output from the second power supply unit to the second device.

10. The method according to claim 9, wherein the information processing apparatus further comprises a PWM control unit PWM-controlling the power supply units; and
in the control step, the current values output from the power supply units to the devices are obtained, and a pulse width of a PWM signal output from the PWM control unit to the power supply units is set in accordance with the obtained current values.

11. The method according to claim 9, wherein in the control step, feedback control is executed with the obtained current values.
